(19) United States
(12) Patent Application Publication
(10) Pub. No.: US 2019/0031094 A1
(43) Pub. Date: Jan. 31, 2019

(54) SYSTEM AND METHOD OF ILLUMINATING A CARGO AREA OF A MOTOR VEHICLE

(71) Applicant: FORD GLOBAL TECHNOLOGIES, LLC, Dearborn, MI (US)

(72) Inventors: Luis Enrique Castillo Jaime, Distrito Federal (MX); Nicole Pamela Herrera Gutierrez, Cuajimalpa (MX); Michelle Carolina Herrera Gutierrez, Cuiajimalpa de Morelos (MX); Scott Holmes Dunham, Redford, MI (US); Stuart C. Salter, White Lake, MI (US)

(21) Appl. No.: 15/659,361

(22) Filed: Jul. 25, 2017

(51) Int. Cl. B60Q 3/30; B62D 43/10; B60R 11/06; B60Q 3/80; B60Q 1/46; B60Q 3/57; F21V 23/04; G09F 13/22; G09F 13/16; G09F 13/02; G09F 21/04

(52) U.S. Cl. CPC B60Q 3/30; B62D 43/10; B60R 11/06; B60Q 3/80; B60Q 1/46; B60R 16/0231; F21V 23/0471; G09F 13/22; G09F 13/16; G09F 13/02; G09F 21/04; B60Q 3/57

(57) ABSTRACT

An illumination system for illuminating a cargo area of a motor vehicle includes a displaceable floor panel, a lift point on the floor panel, a first light source configured to illuminate that lift point and a second light source configured to illuminate a spare tire and tools contained in a well below the floor panel and a third light that illuminates a warning image located on the face oriented toward the rear of the motor vehicle when the floor panel is raised from the well.

### TECHNICAL FIELD

This document relates generally to the motor vehicle equipment field and, more particularly, to a new and improved system and method for illuminating a cargo area of a motor vehicle, particularly, a spare tire and tools held in a well under a floor board in that cargo area. In addition, the system illuminates a warning image located on a face of the floor panel when the floor panel is in a raised position thereby warning other drivers to the presence of the stopped vehicle. The illumination enables the operator to easily extract and manipulate the spare tire and tools held in the well in low ambient light environments.

### BACKGROUND

When a motor vehicle operator must change a tire in a dark environment, for example, such as when the operator is on a highway at night, it is difficult for the operator to retrieve the spare tire and the associated tools. Typically the design of the trunk light is focused to illuminate only the class A view. Thus, the trunk light is usually located in the upper center zone of the trunk of sedan vehicles where the trunk light allows the customer to see in the inside of the trunk and any luggage or cargo being carried on the floorboard.

The spare tire and changing tools for tire replacement are typically located under the trunk floorboard in a well in the super structure of the motor vehicle. In order to access the spare tire and changing tools in this well, the operator must pull the trunk floorboard upward. In such a situation the floorboard is provided between the trunk light at the upper center zone of the trunk and the spare tire and changing tools thereby casting a shadow upon the spare tire and changing tools making them very difficult to see.

While this situation may be addressed by utilizing a flashlight or the light from a cell phone, it should be appreciated that a spare tire and wheel are relatively heavy and cumbersome and that an operator needs free hands to remove the spare tire and changing tools from the trunk. Accordingly, a flashlight or cell phone light is not a good solution to this problem.

This document relates to a new and improved apparatus for illuminating the spare tire as well as the changing tools held in a well under a floorboard of a motor vehicle to thereby allow one to more easily see and access those items when needed.

### SUMMARY

In accordance with the purposes and benefits described herein, a new and improved illumination system is provided. That illumination system comprises (a) a floor panel displaceable between a home position concealing an underlying well and a raised position allowing access to that well, (b) a lift point on the floor panel, (c) a first light source configured to illuminate the lift point when the floor panel is in the home position and (d) a second light source configured to illuminate a spare tire and tools contained in the well when the floor panel is in the raised position.

The floor panel includes a first face oriented away from the well and a second face oriented toward the well. A warning light source may be configured to project light upon the second face when the floor panel is in the raised position. That second face may include a warning image illuminated by the warning light source. The warning image may comprise a luminescent icon and light from the warning light source may excite that luminescent icon causing the luminescent icon to luminesce.

In some embodiments the warning image may also include a reflective material. That reflective material may, for example, comprise reflective glass beads. Further, the illumination system may include a contrasting and highly reflective background on the second face around the warning image.

The illumination system may further include a floor panel position monitoring device such as an infrared (IR) detector. In some of the many possible embodiments, the illumination system may include a controller configured to activate the first light source when a low tire pressure is detected, a transmission is in a park state and a storage compartment closure has been opened. In such an embodiment only the first light source may be activated when the low tire pressure is detected, the transmission is in the park state and the storage compartment closure has been opened.

Further, the controller may be configured to activate the warning light source when the floor panel is displaced from the home position to the raised position. Still further, the controller may be configured to activate warning flashers in response to activation of the warning light source. Still further, the controller may be configured to deactivate the first light source and the warning light source when the floor panel is returned to the home position from the raised position.

In accordance with an additional aspect, a method of illuminating that cargo area of a motor vehicle is provided. That method comprises activating, by a controller, a first light source in response to a low tire pressure indication, a park state transmission status indication and an open storage compartment closure indication and directing a first light from the first light source upon a lift point of a floor panel. For purposes of this document, a lift point may comprise any lug, handle, opening or feature adapted or configured to be manipulated by an individual in order to raise the floor panel.

The method may further include the step of activating, by the controller, a warning light source in response to raising the floor panel from a home position to a raised position. Further, the method may include the step of directing a second light from the warning light source onto the floor panel.

The method may further include the step of exciting a luminescent icon on the floor panel with the second light thereby causing the luminescent icon to luminesce. In addition, the method may include activating, by the controller, warning flashers of the motor vehicle in addition to activation of the warning light source. Still further, the method may include the step of deactivating, by the controller, the first light source and the warning light source when the floor panel is returned to the home position from the raised position.

In the following description, there are shown and described several preferred embodiments of the illumination system and related method of illuminating a cargo area of a motor vehicle in a manner that improves the safety and efficiency of an individual attempting to change a tire of the motor vehicle. As it should be realized, the illumination system and related method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the illumination system and method and together with the description serve to explain certain principles thereof.

FIG. 1 is a schematic block diagram of the illumination system.

FIG. 2 is a schematic block diagram of the controller of the illumination system illustrated in FIG. 1.

FIG. 3 is a schematic illustration of the light sources and floor panel position monitoring device of the illumination system provided behind a single lens located below the trunk sill on the rear wall trim panel of the motor vehicle.

FIG. 4 is a perspective view illustrating the subject matter also shown in FIG. 3 but further illustrating the floor panel raised to allow access to the spare tire and tools stored in the well of the motor vehicle.

FIG. 5 is a rear perspective view of the motor vehicle showing the floor panel raised and the warning image provided on the second face of the floor panel being illuminated by the warning light from the warning light source.

Reference will now be made in detail to the present preferred embodiments of the illumination system and related method, examples of which are illustrated in the accompanying drawing figures.

### DETAILED DESCRIPTION

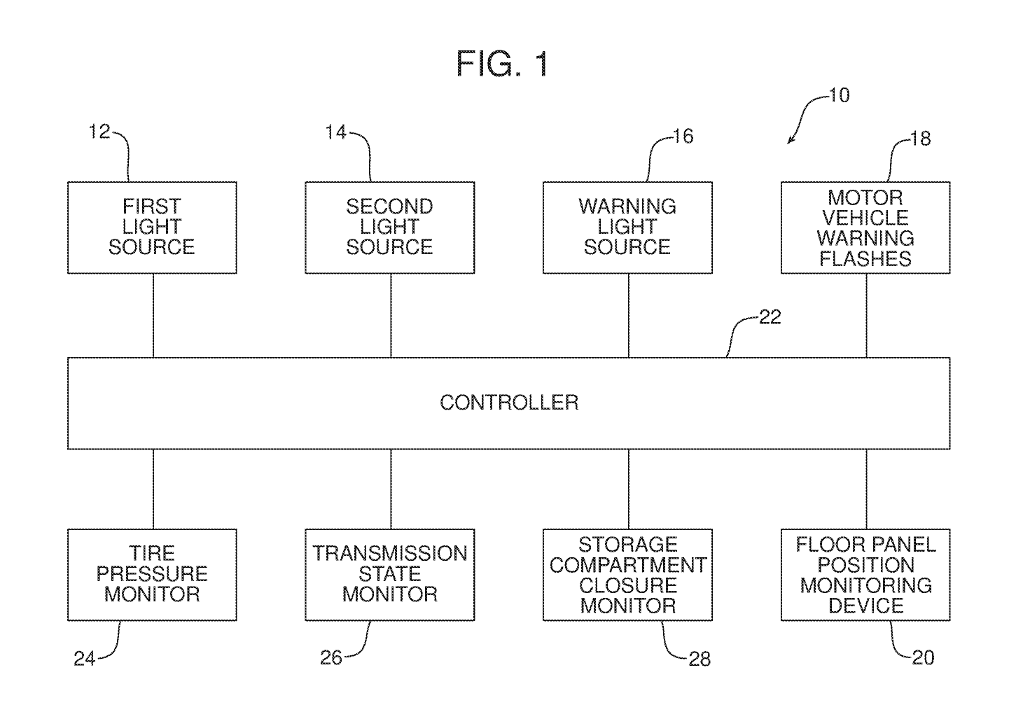

Reference is now made to FIGS. 1-5 illustrating the illumination system 10 for illuminating the cargo area of a motor vehicle in a manner that allows one to more safely and efficiently change a tire in low ambient light conditions such as may be found out on a roadside or other locations. As should be appreciated from reviewing FIG. 1, the illumination system 10 includes a first light source 12, a second light source 14, a warning light source 16, motor vehicle warning flashers 18 and a floor panel monitoring device 20 all under direct control of a controller 22. As further illustrated in FIG. 1, the controller 22 receives data input from a tire pressure monitor 24, a transmission state monitor 26 and a storage compartment closure monitor 28.

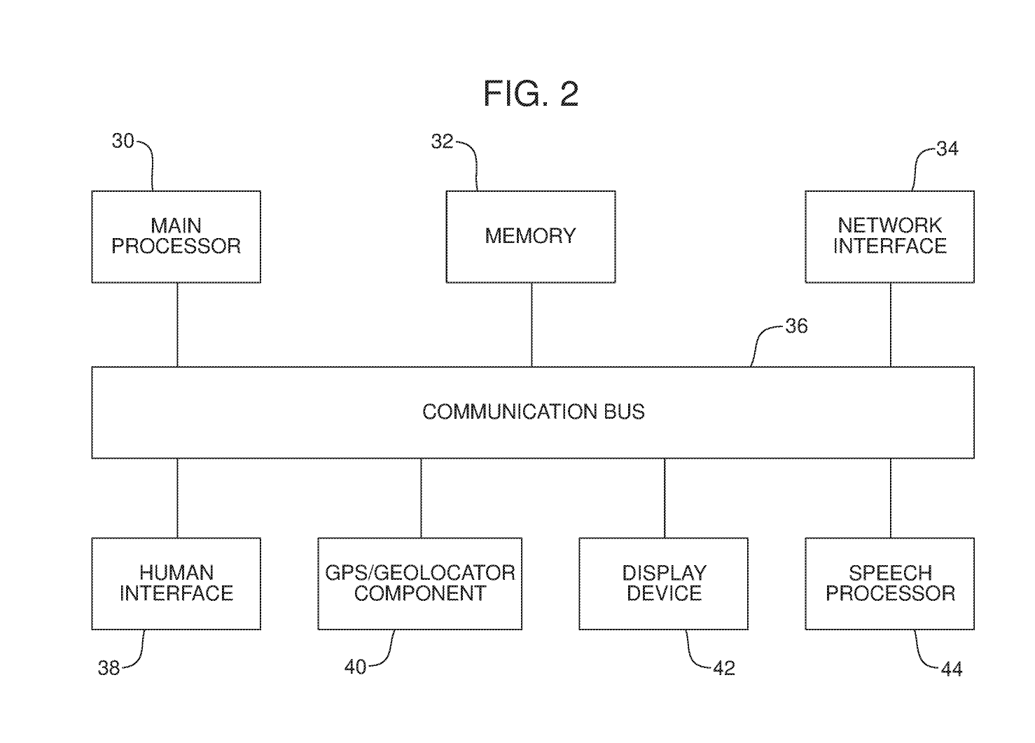

As illustrated in FIG. 2, the controller 22 may comprise a computing device such as a dedicated microprocessor or an electronic control unit (ECU) operating in accordance with instructions received from appropriate control software. Thus, the controller 22 comprises one or more processors 30, one or more memories 32, and one or more network interfaces 34, all in communication with each other over a communication bus 36.

In some embodiments the controller 22 may take the form of a body control module or BCM and also include a human interface 38, a GPS/geolocator component 40, a display device such as a multi-function display with touchscreen capability 42 and a speech processor 44. Advantageously, the speech processor 44 allows for the possibility of voice command and vocal communication interaction with the controller 22 by the motor vehicle operator.

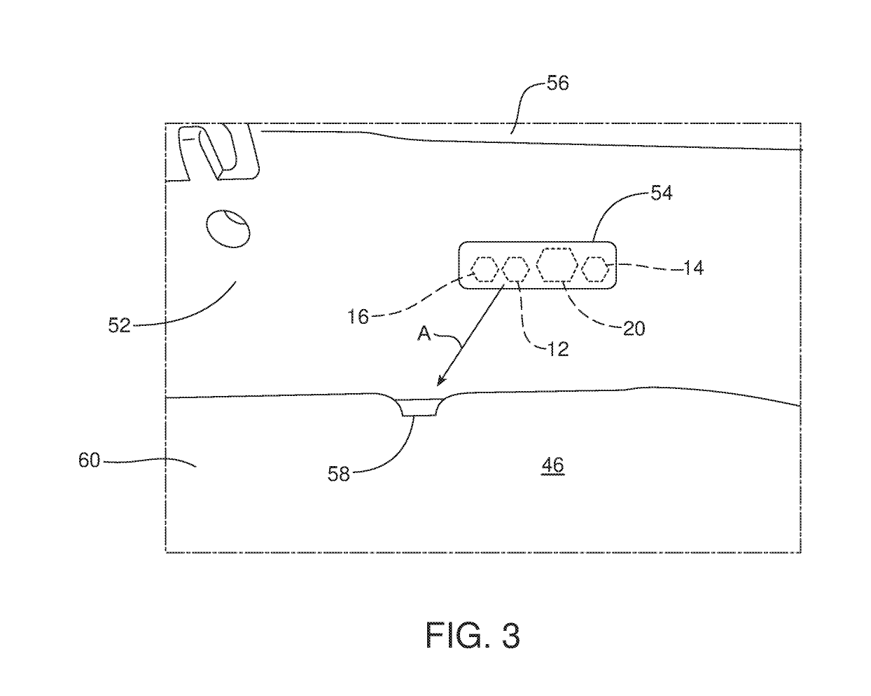

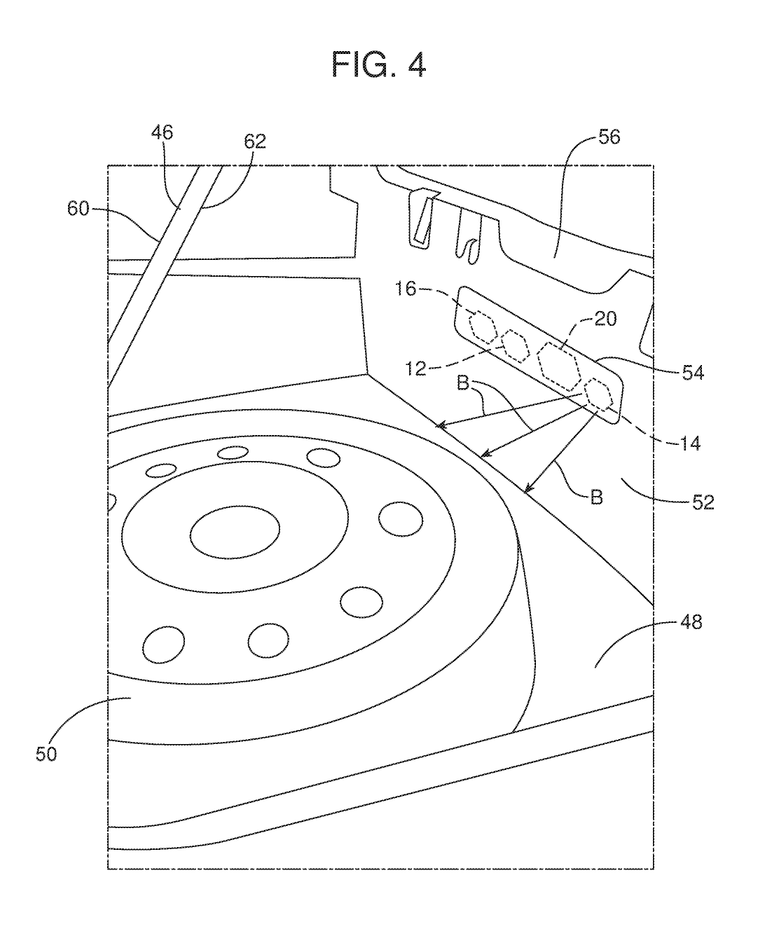

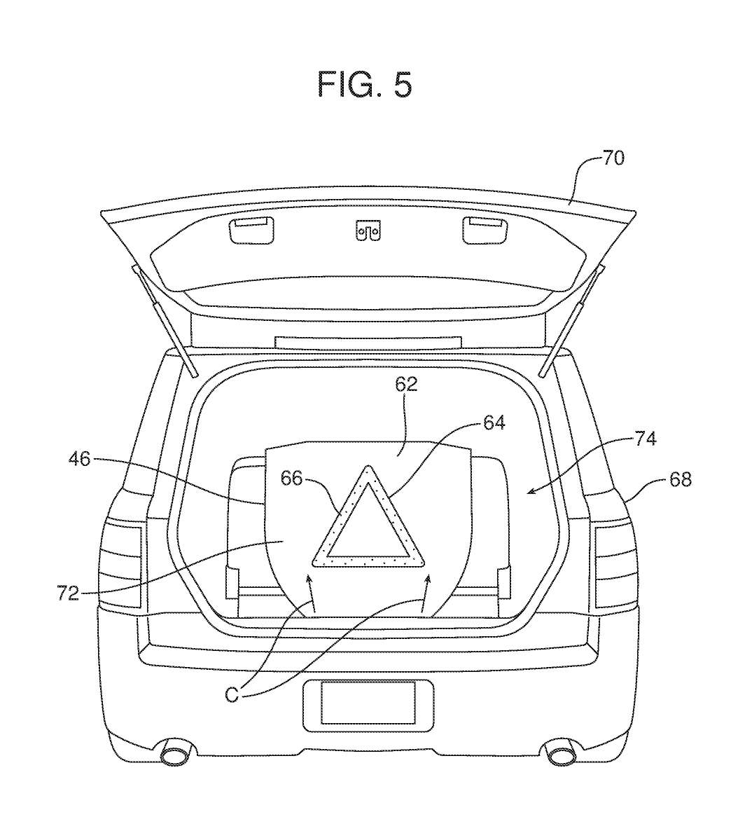

The illumination system 10 also includes a floor panel 46 (see FIGS. 3-5) displaceable between a home position and a raised position. In the home position illustrated in FIG. 3, the floor panel 46 lays flat, concealing an underlying well 48 that holds a spare tire and related tools 50. In the raised position illustrated in FIGS. 4 and 5, the well 48 and the spare tire and related tools 50 are uncovered and may be accessed for use.

The first light source 12, the second light source 14, the warning light source 16 and the floor panel monitoring device 20 may all comprise light emitting diodes (LEDs) that may all be packaged on a trim panel 52 forming the rear wall of the trunk or storage compartment/cargo area. In the illustrated embodiment, the first light source 12, second light source 14, warning light source 16 and floor panel monitoring device 20 are all provided under a single lens 54 provided on the trim panel 52 below the trunk closure sill 56 but above the floor panel 46 when the floor panel is in the home position.

The first light source 12 may comprise a visible light source configured to illuminate a lift point 58 when the floor panel 46 is in the home position.

The second light source 14 is a visible light source configured to illuminate the spare tire and related tools 50 contained in the well 48 when the floor panel 46 is in the raised position.

As further illustrated in FIGS. 3-5, the floor panel 46 includes a first face 60 oriented away from the well 48 and a second face 62 oriented toward the well. The warning light source 16 is configured to project light upon the second face 62 of the floor panel 46 when the floor panel is in the raised position.

As illustrated in FIG. 5, the second face 62 may include a warning image, such as a luminescent icon 64 (hazard triangle). The warning light source 16 is of a selected wavelength adapted to excite the luminescent icon 64 causing the luminescent icon to luminesce. In some embodiments, the warning image/luminescent icon 64 may also include a reflective material such as reflective glass beads 66 to increase the visibility of the warning icon allowing it to reflect headlights from other motor vehicles approaching the motor vehicle 68 from the rear. See FIG. 5 and note how the warning icon 64 is clearly visible from the rear of the motor vehicle 68 when the storage compartment closure 70 and the floor panel 46 are both raised.

A contrasting and highly reflective background 72 may also be provided on the second face 62 around the warning image 64. As shown in FIG. 4, when the floor panel 46 is in the raised position, it is angled with respect to the spare tire and related tools 50 held in the well 48 to allow the reflection of the light down into the well upon the spare tire and related tools 50 thereby enhancing visibility and allowing one to better access and remove the spare tire and related tools for use. Substantially any highly reflective paint or other material may be utilized to provide this contrasting reflective background 72.

As should be appreciated from the above description, the first light source 12 behind the lens 54 may be oriented to direct a first light onto the lift point 58. Note action arrow A in FIG. 3. At the same time, the second light source 14 behind the lens 54 may be oriented to direct a second light upon the spare tire and related tools 50 held in the well 48. Note action arrows B in FIG. 4. The warning light source 16 is oriented specifically to direct light through the lens 54 onto the second face 62 of the floor panel 46 when the floor panel is in the raised position. Note action arrows C in FIG. 5. The floor panel position monitoring device 20 may comprise an infrared (IR) detector incorporating an IR-LED. The infrared LED of the floor panel monitoring device 20 may be oriented to direct light upon the floor panel 46 in order to allow a determination of the position of the floor panel by that monitoring device. If desired, all of the first light source 12, second light source 14, warning light source 16 and floor panel monitoring device 20 may be provided on a single circuit board behind the lens 54 for cost control and simplicity.

The controller 22 may be configured to activate the first light source 12 when a low tire pressure is detected by the tire pressure monitor 24, the transmission of the motor vehicle 68 is in a park state and the storage compartment closure 70 has been opened. Such a tire pressure monitor 24 is of a type known in the art and commonly found in today's motor vehicles. Such a transmission state monitor 26 may comprise a power train control module (PCM) of a type known in the art and configured to transmit vehicle transmission status signals. Such a storage compartment closure monitor 28 is also of a type well known in the art and utilized on many motor vehicles today to monitor the position status of a closure. The controller 22 may also be configured to only activate the first light source 12 and maintain the second light source 14 and warning light source 16 in a deactivated state when a low tire pressure is detected by the tire pressure monitor 24, the transmission is in a park state as detected by the transmission state monitor 26 and the storage compartment closure has been opened as detected and indicated by the storage compartment closure monitor 28. Advantageously, the lone activation of the first light source 12 will ensure that the only visible light in the cargo area is directed upon the lift point 58 thereby ensuring to direct the attention of the user to the lift point which will allow the user to raise the floor panel 46.

The controller 22 may be further configured to activate the warning light source 16 when the floor panel 46 has been displaced from the home position illustrated in FIG. 3 to the raised position illustrated in FIGS. 4 and 5. Light from the warning light source 16 is then directed upon the second face 62 of the floor panel 46 causing the warning icon 64 to luminesce while the contrast and reflective background 72 reflects visible light downward onto the spare tire and related tools 50 held in the well 48. In some embodiments, the controller 22 may be further configured to activate the warning flashers 18 in response to or at the same time the warning light source 16 is activated. This helps to ensure the safety and security of any individual seeking to change a tire of the motor vehicle 68.

In some embodiments, the controller 22 is also configured to deactivate the first light source 12 and the warning light source 16 when the floor panel 46 is returned to the home position from the raised position as detected and indicated by the floor panel position monitoring device 20.

Consistent with the above description, a method is provided of illuminating a storage compartment or cargo area 74 of a motor vehicle 68. That method broadly comprises the steps of activating, by the controller 22, the first light source 12 in response to a low tire pressure indication received from the tire pressure monitor 24, a park state transmission status indication received from the transmission state monitor 26 and an open storage compartment closure indication received from the storage compartment closure monitor 28. Further, the method includes the step of directing the first light from the first light source 12 upon the lift point 58 of the floor panel 46.

The method further includes the step of activating by the controller 22, the warning light source 16 in response to raising of the floor panel 46 from the home position to the raised position as monitored and indicated by the floor panel position monitoring device 20. Further, the method may include the step of directing a second light from the warning light source 16 onto the floor panel and, more particularly, the second face 62 of the floor panel 46. In this regard it should be appreciated that the method may include exciting a luminescent icon 64 on the second face 62 of the floor panel 46 with the second light thereby causing the luminescent icon to luminesce.

Further, the method may include the step of activating, by the controller 22, the warning flashers 18 of the motor vehicle 68 when the warning light source 16 is activated, if those warning flashers had not been previously activated by the motor vehicle operator. This action helps to ensure the safety of the individual while changing a tire.

Still further, the method may include the step of deactivating, by the controller 22, the first light source 12 and the warning light source 16 when the floor panel is returned to the home position from the raised position.

In summary, a number of benefits and advantages are provided by the illumination system and method disclosed in this document. The controller 22 and first light source 12 function together to provide a light effect that prompts the user to find the lift point 58 to raise the floor panel 46. The controller 22 and the second light source 14 function together to illuminate the spare tire and related tools 50 in the well 48 thereby enhancing visibility and making their access and removal much easier for the individual seeking to change a tire. Advantageously, the reflective background 72 of white paint or other appropriate reflective material creates a diffuse low glare lighting across the whole trunk area. At the same time, the contrasting reflective background 62 provides a highly visible background for the luminescent warning icon 64.

The warning light source 16 may comprise a high color temp (bluish white) LED which contains a high amount of blue light which can excite a warning icon 64 containing rylene dye. By adding reflective glass beads 66 to the warning icon 64, the warning icon can be made highly reflective so as to reflect headlights from approaching motor vehicles in a manner similar to a road sign. This ensures that the warning icon 64 is effective even if the warning light source 16 is inoperative for any reason such as a low motor vehicle battery. Further, it allows one to remove the floor panel 46 from the storage compartment 74 and position the luminescent safety icon 64 behind the motor vehicle if desired where it will be fully seen when illuminated by the lights of an approaching vehicle. As should also be appreciated, the controller 22 of the illumination system 10 may be configured to operate the first light source 12, the second light source 14 and the warning light source 16 in a specific sequence to best benefit and advantage the motor vehicle operator during the tire changing process.

The foregoing has been presented for purposes of illustration and description. It is not intended to be exhaustive or to limit the embodiments to the precise form disclosed. Obvious modifications and variations are possible in light of the above teachings. For example, the luminescent icon 64 or background 72 may incorporate a long persistent phosphor paint that will charge up in a couple minutes and allow the floor panel 46 to be removed from the cargo area 74 and used by the tire changer to further illuminate the wheel well area enhancing visibility for the tire changing activity. All such modifications and variations are within the scope of the appended claims when interpreted in accordance with the breadth to which they are fairly, legally and equitably entitled.

What is claimed:

1. An illumination system, comprising:
a floor panel displaceable between a home position concealing an underlying well and a raised position allowing access to said well;
a lift point on said floor panel;
a first light source configured to illuminate said lift point when said floor panel is in said home position; and
a second light source configured to illuminate a spare tire and tools contained in said well when said floor panel is in said raised position.

2. The illumination system of claim 1, wherein said floor panel includes a first face oriented away from said well and a second face oriented toward said well.

3. The illumination system of claim 2, further including a warning light source configured to project light upon said second face when said floor panel is in said raised position.

4. The illumination system of claim 3, wherein said second face includes a warning image illuminated by said warning light source.

5. The illumination system of claim 4, wherein said warning image is a luminescent icon and light from said warning light source excites said luminescent icon causing said luminescent icon to luminesce.

6. The illumination system of claim 5, wherein said warning image also includes a reflective material.

7. The illumination system of claim 6, wherein said reflective material is reflective glass beads.

8. The illumination system of claim 7, further including a contrasting and highly reflective background on said second face on said warning image.

9. The illumination system of claim 4, further including a floor panel position monitoring device.

10. The illumination system of claim 9, further including a controller configured to activate said first light source when a low tire pressure is detected, a transmission is in a park state and a storage compartment closure has been opened.

11. The illumination system of claim 10, wherein only said first light source is activated when said low tire pressure is detected, said transmission is in said park state and said storage compartment closure has been opened.

12. The illumination system of claim 10, wherein said controller is configured to activate said warning light source when said floor panel is displaced from said home position to said raised position.

13. The illumination system of claim 12, wherein said controller is configured to activate warning flashers in response to activation of said warning light source.

14. The illumination system of claim 13, wherein said controller is configured to deactivate said first light source and said warning light source when said floor panel is returned to said home position from said raised position.

15. The illumination system of claim 14, wherein said floor panel position monitoring device is an infrared detector.

16. A method of illuminating a cargo area of a motor vehicle, comprising:
activating, by a controller, a first light source in response to a low tire pressure indication, a park state transmission status indication and an open storage compartment closure indication; and
directing a first light from said first light source upon a lift point of a floor panel.

17. The method of claim 16, further including activating, by said controller, a warning light source in response to raising of said floor panel from a home position to a raised position and directing a second light from said warning light source onto said floor panel.

18. The method of claim 17, further including exciting a luminescent icon on said floor panel with said second light thereby causing said luminescent icon to luminesce.

19. The method of claim 18, further including activating, by said controller, warning flashers of said motor vehicle.

20. The method of claim 19, further including deactivating, by said controller, said first light source and said warning light source when said floor panel is returned to said home position from said raised position.
